(19) United States
(12) Patent Application Publication
(10) Pub. No.: US 2013/0227398 A1
(43) Pub. Date: Aug. 29, 2013

(54) PAGE BASED NAVIGATION AND PRESENTATION OF WEB CONTENT

(71) Applicant: Lars Erik BOLSTAD, Oslo (NO)

(72) Inventor: Lars Erik BOLSTAD, Oslo (NO)

(73) Assignee: OPERA SOFTWARE ASA, Oslo (NO)

(21) Appl. No.: 13/592,575

(22) Filed: Aug. 23, 2012

Related U.S. Application Data
(60) Provisional application No. 61/526,593, filed on Aug. 23, 2011.

(51) Int. Cl. G06F 17/22

(52) U.S. Cl. CPC G06F 17/2247
USPC 715/236; 715/234

(57) ABSTRACT

A first aspect of the present invention is directed to a method whereby a web browser rearranges the content of a retrieved webpage into multiple discrete screen pages, and displays the discrete screen pages one at a time. According to the first aspect, the user can navigate the content by performing simple “Page Up” or “Page Down” commands to view a next or previous discrete screen page. A second aspect of the present invention is directed to a method whereby code within a currently-loaded webpage is processed by a browser to implement simple directional navigational commands for use in displaying other webpages. In the second aspect, these navigation commands do not require entry of a URL or clicking on a particular link. For example, such navigation commands may comprise a touchscreen gestures to navigate beyond the upper, lower, left, or right edge of the webpage.

### FIELD OF THE INVENTION

The invention relates to navigation and presentation of web content such as web pages and other web documents, and particularly to page based presentation and navigation inside web documents as well as between web documents.

### BACKGROUND OF THE INVENTION

When web media content such as web pages and other web documents are displayed by web browsers they are displayed as one large page that may extend outside the viewport created by the browser window, both in the horizontal and the vertical direction. When a user reads or looks at the content of a document, he or she must move the document relative to the viewport, known as scrolling, in order to see content that is outside the current position of the viewport.

Furthermore, the only relationship between documents are presented as links that can be invoked by a user in order to load a subsequent document after viewing the document currently loaded, or to invoke a “back” command in order to reload a previously loaded document in the browsing history, and a “forward” command in order to move forward in the browsing history after using the “back” command. Some web browsers also provide a “fast forward” and a “rewind” command—possibly using different names depending on the make of the browser—which can be invoked if the browser has detected a link in the current page that is assumed to be a link to a following or previous document in a set of related documents. Such an assumption can for example be based on the presence of words like “next,” “forward,” “previous” or “page 2” in a link attribute, the link text, or the URL of a hyperlink in a currently loaded document.

When users access web content using new devices with touch screens, for example tablets or smartphones, the gradual scrolling and the invoking of hyperlinks is less convenient for several reasons related to usability and convenience. As a result, small applications, known as “apps,” for reading or viewing content such as web pages and e-books have been turning towards a more traditional book-like presentation, where content is presented on a page by page basis such that users do not scroll gradually through the content. Instead the content is presented as entire pages, and the user can only move forward or back by going from one page to the next without any overlap of content between the two. However, this has required that content and the app be designed for each other. In particular, the content must be designed such that for example headlines, images and text can be displayed consistently on entire pages; the integrity of each page must be preserved; and many types of content, for example images, headlines and tables, cannot be allowed to span several pages.

Furthermore, users expect to be able to move from one page to the next using commands or gestures, and they expect to be able to use the same commands and gestures even if the “next” page is part of a new document.

### SUMMARY OF THE INVENTION

According to a first aspect of the present invention, a web browser is configured to rearrange the content of a retrieved webpage into multiple discrete screen pages, which are displayed one-at-a-time, rather than as a single scrollable page. According to the first aspect, the user can navigate the content by performing simple “Page Up” or “Page Down” commands to view a next or previous discrete screen page.

A second aspect of the present invention is directed to a method whereby code within a currently-loaded webpage is processed by a browser to implement simple navigational commands for use in displaying other webpages. In the second aspect, these navigation commands do not require entry of a URL or clicking on a particular link. For example, such navigation commands may comprise a directional gestures such as up, down, left, or right.

### BRIEF DESCRIPTION OF THE DRAWINGS

FIG. 1 illustrates the basic architecture of a computing device that can operate as either a client device or a server according to exemplary embodiments of the present invention;

FIG. 2 illustrates the basic architecture of a web browser implemented on a client device according to an exemplary embodiment of the present invention;

FIG. 3 is a flowchart illustrating an example implementation of a “Screen Pages” method consistent with a first aspect of the present invention; and

FIG. 4 is a flowchart illustrating an example implementation of an “Auto-Triggered Pages” method consistent with a second aspect of the present invention.

### DETAILED DESCRIPTION

The present invention seeks to improve or provide alternatives to the manner in which users traditionally access, view and navigate web content. Particularly, exemplary embodiments of the present invention are designed to provide a user with a presentation of content based on page views, and navigation of the document by transitioning between entire pages rather than through continuous scrolling. Exemplary embodiments also include a similar way of navigating between documents, e.g., the loading a new document from a currently loaded document may be invoked using the same or a similar command or input gesture as that used to move from one page to the next inside a document.

The principles of the present invention may be implemented in a mobile environment in which users are able to browse the Internet using their mobile devices (phone, tablet computer, etc.), e.g., via a 3G or 4G-compliant network or a wireless network based on Wi-Fi (IEEE 802.11), WiMAX (IEEE 802.16) or any other available standard for wireless communication. However, the present invention is not limited to a mobile implementation, and the principles described herein may also be applied to a desktop browsing environment.

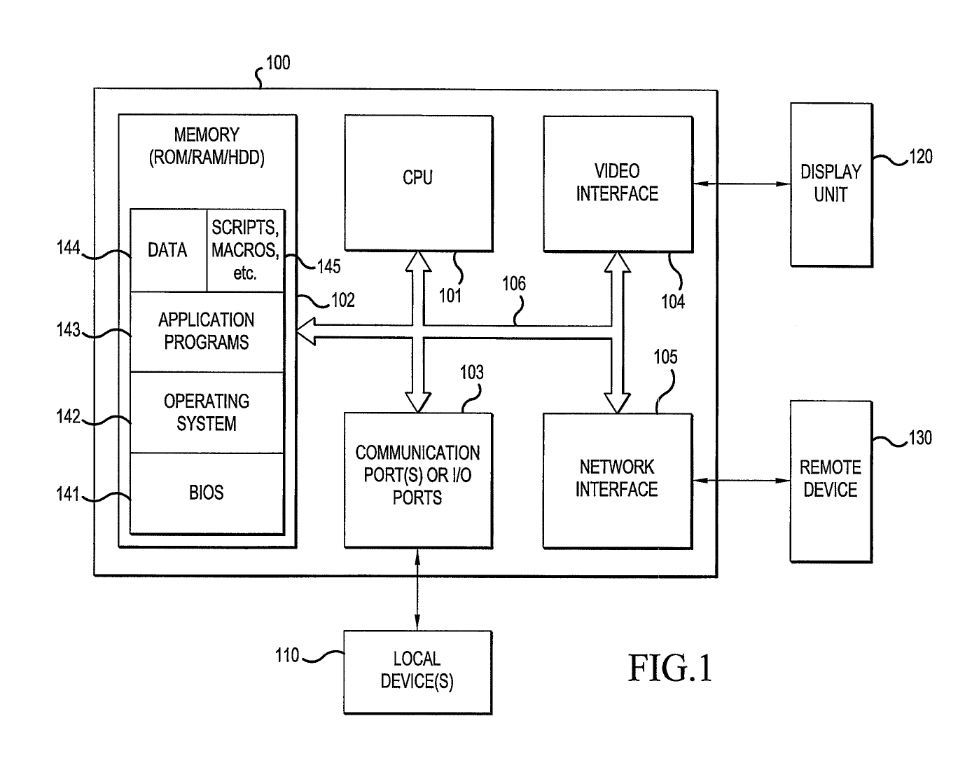

FIG. 1 illustrates a generalized computing device 100 that can be used as an environment for implementing various aspects of the present invention. For instance, the computing device 100 may be implemented as a client device, i.e., a user's computing device on which a web browser is installed to request webpages or resources from the server. Examples of such client devices include a mobile device (e.g., a cellphone, a smartphone, a tablet computer, etc.) or a general purpose desktop computer such as a PC. However, the computing device 100 of FIG. 1 may also be implemented as a server-side device, e.g., as a web server, a proxy server, or another specialized computing device as will be describe in more detail below.

In FIG. 1, a computing device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memories, stores the various software components of the system. The software components in the memory 102 may include a basic input/output system (BIOS) 141, an operating system 142, various computer programs 143 including applications and device drivers, various types of data 144, and other executable files or instructions such as macros and scripts 145. For instance, the computer programs 143 stored within the memory 102 may include any number of applications, including a web browser and other web applications that may be executed in accordance with principles of the present invention.

In FIG. 1, the communication ports 103 may be connected to one or more local devices 110 such as user input devices, a printer, a media player, external memory devices, and special purpose devices such as, e.g., a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for local devices 110.

The video interface device 104 is connected to a display unit 120 which may be an external monitor or an integrated display such as an LCD display. The display unit 120 may have a touch sensitive screen and in that case the display unit 120 doubles as a user input device. The user input device aspects of the display unit 120 may be considered as one of the local devices 110 communicating over a communication port 103.

The network interface device 105 provides the device 100 with the ability to connect to a network in order to communicate with a remote device 130. Such network, which in FIG. 1 is only illustrated as the line connecting the network interface 105 with the remote device 130, may be, e.g., a local area network or the Internet. The remote device 130 may in principle be any computing device (e.g., client or server) with similar communications capabilities as the device 100.

It will be understood that the device 100 illustrated in FIG. 1 is not limited to any particular configuration or embodiment regarding its size, resources, or physical implementation of components. For example, more than one of the functional components illustrated in FIG. 1 may be combined into a single integrated unit of the device 100. Also, a single functional component of FIG. 1 may be distributed over several physical units. Other units or capabilities may of course also be present.

In an exemplary embodiment, various aspects of the present invention may be incorporated into, or used in connection with, the components and/or functionality making up a web browser installed as an application on a device 100. While the terms “web browser” and “browser” are used throughout this specification, it should be understood that such terms are not intended to limit the present application only to traditional web browser programs, but instead cover any type of user agent or web application that is capable of sending URL requests for data resources (including, but not limited to, web pages) over the World Wide Web consistent with the principles of the present invention. Certain embodiments of the invention may also involve applications that access content that has already been made available locally without communicating with other networked devices.

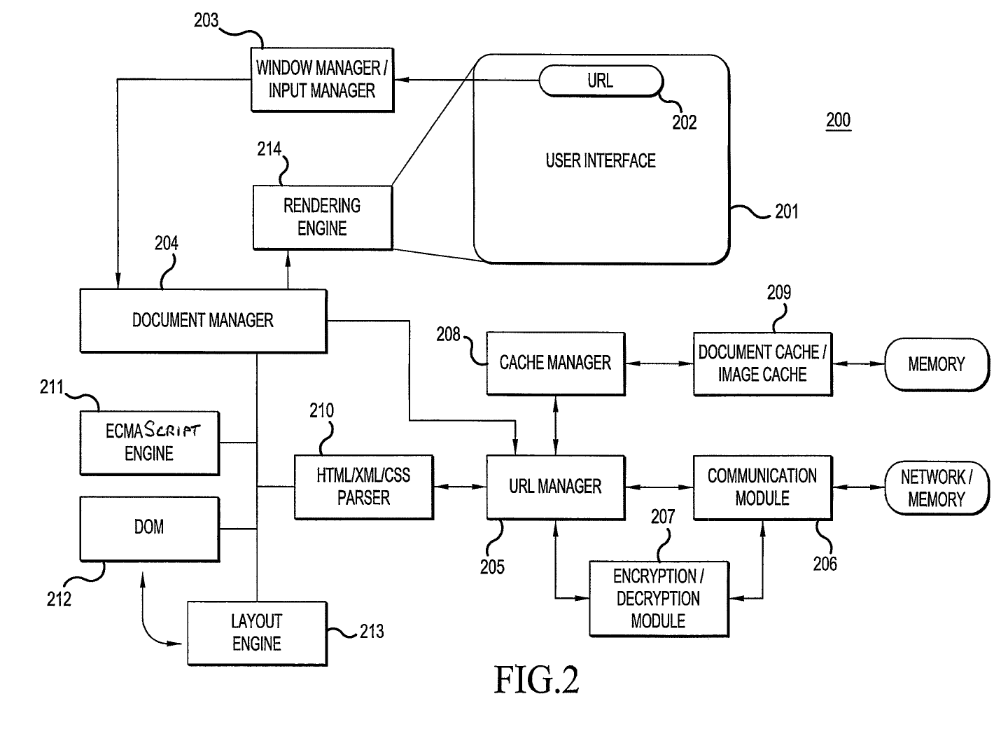

FIG. 2 illustrates the basic architecture of a web browser 200 that can be used in connection with the present invention. Particularly, FIG. 2 shows an example of various modules that may be present in such a web browser 200. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The web browser 200 presents the user with a user interface 201 that may be displayed on the display unit 120 shown in FIG. 1. The user interface 201 may include an address field 202 in which the user may input or select the URL of a document or a service he or she wants the browser 200 to retrieve. For example, the user may use an input device (e.g., keyboard) to type in the URL in the address field 202. The address field 202 may also be a link that is displayed and may be activated by the user using a pointing device such as a mouse. Alternatively the URL may be specified in the code of a document or script already loaded by the web browser 200.

In any case, the URL may be received by a window and input manager 203 that represents the input part of the user interface 201 associated with, or part of, the browser 200. The URL may then be forwarded to a document manager 204, which manages the data received as part of the document identified by the URL.

The document manager 204 forwards the URL to a URL manager 205, which instructs a communication module 206 to generate a web page request, i.e., a request for access to the identified resource. The communication module 206 may be capable of accessing and retrieving data from a remote device 130 such as a server over a network using the hypertext transfer protocol (HTTP), or some other protocol such as HTTP Secure (HTTPS) or file transfer protocol (FTP). The communication module 206 may also be capable of accessing data that is stored in the local memory 102 of the computing device 100.

Referring again to FIG. 2, the web browser 200 may include an encryption/decryption module 207 to handle communication between the URL manager 205 and the communication module 206, if communication outside the computing device 100 is required to be encrypted (e.g., as specified by the protocol used for accessing the URL).

The data received by the communication unit 206 in response to a webpage request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication port 206 or cache 209 to a parser 210 capable of parsing content such as HTML, XML and CSS. The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU 101 of computing device 100 as the CPU 101 receives instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the web browser 200 described above may be implemented as an application program 143 of the computing device 100, some of the browser's 200 functionality may also be implemented as part of the operating system 142 or even the BIOS 141 of the device 100. Further, the content received in response to a webpage request may include data 144, script 145, or a combination thereof.

A webpage is a document typically written in HTML, XHTML or other similar markup languages. Often, HTML pages are styled with CSS style sheets and combined with images (e.g., in JPEG, GIF or PNG formats), video (e.g., in the WebM format) or plugins (e.g., in the SWF format) in order to form comprehensive visual presentations. These presentations, which are typically generated by the rendering engine 214 of a web browser 200, as described above in connection with FIG. 2, often require more space than a user's computer screen or user interface 201 can offer. Typically, web browsers have solved this problem by offering a vertical “scroll bar” on the side of the webpage so that the user can scroll from the top to the bottom of the web page. Likewise, when the webpage is wider than the user's computer screen, a horizontal scroll bar is offered. By using these scrollbars, the user is able to view the entire web page.

Scrollbars, however, are inconvenient in some circumstances. Some computers, typically of the ‘tablet’ kind, do not have a mouse (which is typically used with scrollbars). Also, some of the screens used by tablet computers are of the ‘electronic paper’ kind which takes about a second to refresh; this is too slow for use with scrollbars or other methods of continuous scrolling.

To overcome the limitations of scrollbars, a first aspect of the present invention is directed to an alternative method of presenting web pages to users, which will be referred to hereinbelow as “Screen Pages.” Instead of scrolling a web page, the web page is split into one or more discrete screen pages such that each screen page is no bigger than the space available. The user moves from one screen page to the next by selecting “Page Down,” by providing a gesture, or by using some other mechanism. Likewise, the user can move to the previous page by selecting “Page Up,” by providing a gesture, or by using some other mechanism. Thus, screen pages offer an alternative to continuous scrolling, one that is more suitable for tablets and smaller screens.

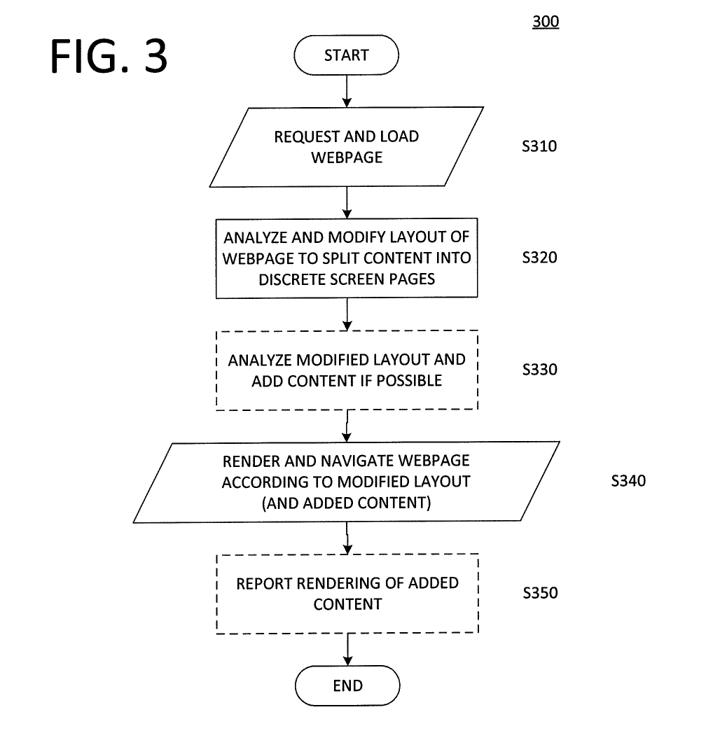

FIG. 3 is a flowchart illustrating an example implementation of a Screen Pages method consistent with a first aspect of the present invention. As illustrated in FIG. 3, the method 300 starts by requesting and loading a webpage according to operation S310. For example, in S310, the webpage is requested and loaded as described above with reference to FIG. 2. As part of operation S310, any embedded content of the webpage, such as images and content requiring plug-ins (e.g., SWF file), may be received by the web browser 200.

Thereafter, the webpage is processed according to operation S320 in order to analyze and modify the layout of the webpage so that the content will be rendered by the web browser 200 as multiple discrete screen pages (which are displayed one at a time), rather than a single scrollable page. Such analysis and modifications may be performed, e.g., by the rendering engine 214 of the web browser 200. According to S320, various heuristics may be used to categorize the different parts of the content, and determine if and how particular elements should be modified. These heuristics may be implemented entirely in the browser 200. No special code is needed in the markup language document in order for screen pages to be used; the browser 200 may use heuristics and normal CSS code to determine how to break the webpage into one or more discrete screen pages.

For example, in S320, webpage elements may be categorized based on tags in the markup language code, media type and CSS code. As such, content could, for example, be classified into one of multiple classifications such as: heading material, body text or main content, content supplemental to the main content (e.g., image or content requiring a plug-in), advertising, footer, legal disclaimer, sidebar or navigation bar content, part of an index to related content, etc. Based on such categorizations, the rendering engine 214 may be able to enforce certain rules in order to modify elements and/or the relationships between multiple elements on the webpage, so that the webpage content can be split into multiple discrete screen pages.

An example of such a rule could be that, if the webpage represents a topical article in a website, an image in the webpage should be placed on the front page, i.e., the first screen page, and it should be scaled to take up approximately 30% of the available space. Another possible rule may specify that advertising should be placed on the first screen page. Alternatively, the rule may specify that advertising be placed on the last screen page (i.e., at the end of the article) if there is unused space on the last screen page. According to another rule, any legal disclaimer may be placed on the last screen page, possibly in addition to advertising. Alternatively, a rule may indicate that the disclaimer is to be placed at the bottom of every screen page.

It will be understood that the same rules do not necessarily have to be applied in each and every webpage. Instead, according to some embodiments of the invention, the choice of which rules are applied is made dynamically based on the characteristics of the loaded webpage. For example, the ratio of images to text in a webpage may be determinative of whether a rule will be applied to scale images to a particular percentage of each screen page. As another example, some webpages may be rendered with a legal disclaimer on the bottom of each screen page, while other web pages are rendered with a legal disclaimer only on the bottom of each screen page.

Furthermore, in an exemplary embodiment, the particular rules or heuristics applied in S320 may be tailored to the viewport dimensions of the computing device 100 in which the web browser 200 is installed. For instance, the rules may be designed to make sure that each discrete screen page fits within the viewport of the device 100. The rules may also be adapted to the current dimensions of the main browser window. In addition, the heuristics may be dynamically adaptable, in such manner that the shape and size of the discrete screen pages can be adapted to any resizing of the browser window, e.g., by the user.

In addition, it will be understood by those with skill in the art that the selection of heuristics and the way they are tuned to each other in order to organize and scale content in a preferred manner is a matter of design choice and that it is impossible to provide a complete list of content categorization, rules and tuning parameters. However, techniques that have been used in order to adapt webpages to small and medium size displays are among those that can be adapted to the present invention. Such techniques are, for example, described in U.S. patent applications Ser. Nos. 10/654,455, 10/956,019, 10/936,552, 11/267,316, 10/982,953, 11/517,524, 11/525,177, and 12/423,968, each of which is hereby incorporated by reference in its entirety.

Furthermore, operation S320 may be designed to honor any CSS properties that would influence pagination. For instance, conventional web browsers need to perform pagination when printing documents, and CSS provide certain elements to influence where the page breaks can occur (see, e.g., “Cascading Style Sheets Level 2 Revision 1 (CSS 2.1) Specification,” Jun. 7, 2011 Recommendation, edited by Bert Bos et al., published by World Wide Web Consortium (W3C), Chapter 13 (“Paged media”), the entire contents of which are herein incorporated by reference). Examples of the CSS properties that may be defined in a webpage in regard to pagination include: “h1 {page-break-before: always},” “blockquote {page-break-after}” and p {orphans: 1, windows 1}.” According to an exemplary embodiment of the present invention, the web browser 200 may be designed to analyze the CSS properties regarding pagination when modifying the layout in S320, so that the discrete screen pages are defined in accordance with such properties.

Referring again to FIG. 3, after operation S320 has been performed, it might be common for the last screen page to have a blank area. The size, shape, and locations of the blank areas in the modified webpage will vary based on factors such as the heuristics used for splitting the content into discrete screen pages, the size and shape of the screen pages (which may be dictated by the size and shape of the screen of the computer device 100), the size of the fonts used, etc. Further, there may be additional content (e.g., advertisements) which can be presented within such blank spaces. The browser may therefore be configured to retrieve and display such additional content.

Thus, operation S330 may be performed by the browser 200 in order to analyze the modified layout to find blank areas, and provide additional content to be presented within the blank areas. The performance of operation S330 may be optional (as depicted by the dotted lines). For instance, it could be made dependent on factors including whether the browser 200 has been configured to retrieve such content from a compatible repository, whether the source website has made additional content available, and whether the user of the web browser 200 activates a setting to allow for the addition of such content.

As an example, operation S330 may be used to insert additional advertisements to the available blank areas. In this example, S330 may need to analyze the size and shape of any available blank areas, and then select from available advertisements (e.g., in a database) those which best match the respective blank areas based on their size and shape (and possibly other factors such as user profile, browsing history, contents of the current page etc.). The selected advertisements are then made available for display in the blank areas when the corresponding screen pages are rendered.

Referring again to FIG. 3, after the layout is modified (and content is possibly added), the webpage may be rendered by the browser 200, and navigated by the user, as discrete screen pages according to operation S340. As mentioned earlier, the user may move between discrete screen pages using gestures or mechanisms representing “Page Down” and “Page Up” commands. However, the user may also jump out of sequence to another screen page, for example, by using a “Go To” command.

According to a further embodiment, the browser 200 may optionally be configured to report, e.g., to an external server, whether any additional content was added to blank spaces within the rendered screen pages as illustrated in S350. For instance, this may be used to allow a source website or other entity to track which advertisements have been used, possibly to receive financial compensation from an advertiser.

It should be noted that a point of novelty of the Screen Pages method described above is that, whereas conventional web browsers have utilized pagination algorithms solely for the purpose of printing a webpage of portion thereof, the Screen Pages method applies the concept of pagination to the display and navigation functions of a browser 200.

The first aspect of the present invention, i.e., the Screen Pages method described above, provides an effective way of navigating within web pages without the use of scrollbars. However, a second aspect of the present invention provides a way in which a user can navigate to other webpages without clicking on links.

As part of the conventional browsing scheme, the user navigates between different webpages by selecting (e.g., clicking on) hyperlinks, or by going back in history. However, the second aspect of the present invention described hereinbelow provides an alternative method of navigation referred to as “Auto-Triggered Pages.” The Auto-Triggered Pages method of navigation is more akin to how a person reads a newspaper, where the person need only shift his view across any border of the current article in order to view another article.

Specifically, when the Auto-Triggered Pages feature of the present invention is activated within a web browser 200, a user can navigate to another web page by performing an action related to an edge of the document. For instance, when the user is currently viewing one webpage, he may be capable of switching to another webpage simply by performing a gesture that attempts to navigate (or move the viewport) beyond the upper, lower, left, or right edge of the document.

Gestures for navigating beyond one of the edges of a webpage document can be implemented in various ways. For example, a web browser 200 according to the invention may be implemented in a computing device 100 which includes a touchscreen interface. In this case, a user may perform a “drag” or “flick” gesture to move the viewport beyond any of the edges of the current document. Such gestures are usually performed by pressing one's finger or stylus somewhere on the displayed document and moving it in a particular direction in order to move the viewport across the opposite edge. For example, to navigate beyond the lower edge of the displayed webpage, a user would touch and drag his finger in an upward motion. However, other types of gestures may be used in a touchscreen device to navigate beyond any of the edges of a document as will be contemplated by those skilled in the art.

For purposes of this description, a user gesture for moving the viewport beyond the edge of a current webpage is referred to hereinafter as a “directional navigation command.” For instance, a gesture for navigating or moving the viewport beyond the lower edge of a document is referred to as a “Down” navigation command. Similarly, a gesture for navigating beyond the left edge is referred to as a “Left” navigation command, a gesture for navigating beyond the right edge is a “Right” navigation command, and a gesture for navigating beyond the upper edge is an “Up” navigation command.

However, for certain computing devices 100, other inputs besides touchscreen gestures may be used to perform the aforementioned directional navigation commands as part of the Auto-Triggered Pages method. For example, directional navigation commands may also (or alternatively) be performed by moving an input device (e.g., an electronic mouse or joystick) in the appropriate direction. Other alternatives for performing directional navigation commands according to the Auto-Triggered Pages feature may take the forms of inputs such as key combinations, clicking on appropriate icons or buttons displayed on the screen, dedicated hardware buttons, etc.

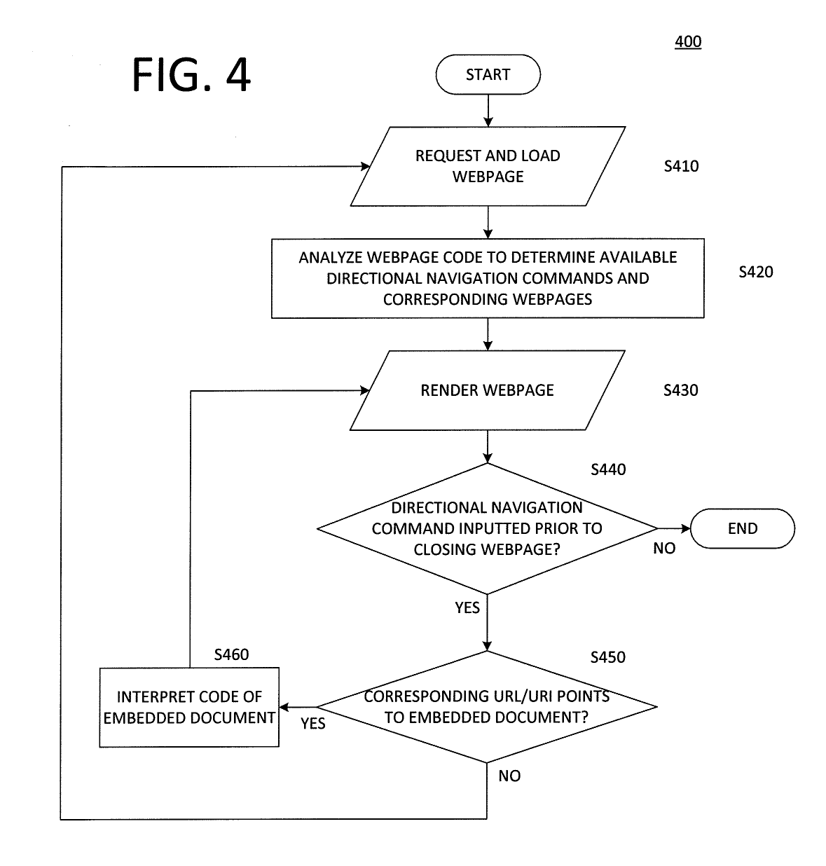

FIG. 4 is a flowchart illustrating an example implementation of an “Auto-Triggered Pages” method consistent with a second aspect of the present invention. In operation S410, a webpage is requested and loaded by the browser 200, e.g., according to conventional process described above in connection with FIG. 2. According to operation S420, the browser 200 analyzes code within the webpage in order to determine what directional navigation commands (by gesture or other input) are available, and which webpages are to be displayed when the respective commands are performed.

For example, S420 may analyze CSS code within, or associated with, the loaded webpage document to determine the webpages for each directional navigation command. An example of such CSS code is provided below:

```
@navigation {
  nav-up: url-doc(index.html);
  nav-right: url-doc(a3.html);
  nav-down: url-doc(ad.html);
  nav-left: uri-doc(a1.html);
}
```

In this particular example, the above code would indicate to the browser 200 that an “Up” navigation command should result in the loading of the document “index.html” from the same directory on the web server as the current document. Similarly, a “Right” navigation command should initiate loading of the document “a3.html”, a “Left” navigation command should load “a1.html”, and a “Down” navigation command should load the document “ad.html,” (each of these documents similarly being available for loading from the same directory of the web server as the current webpage).

Although the above example illustrates CSS code for correlating directional navigation commands to webpages or documents that are found in the same directory of the web server as the currently loaded webpage, this need not be the case. Such CSS coding could be adapted to correlate one or more of the aforementioned directional navigation commands to the loading of a webpage from a different directory, or even a different server (e.g., by specifying the URL of a different website in the above code). As another alternative, CSS code could be used to correlate a directional navigation command to a URL or URI of a document which is embedded in the loaded webpage, but not currently displayed.

Furthermore, as part of the Auto-Triggered Pages method of the invention, documents may rely on metadata in HTML to define logical relationships between documents, and CSS may then be used by the browser 200 in operation S420 to translate this logical relationship to e.g. directional navigation commands. The following is an example of HTML metadata that may be included in a document:

| | |
|---|---|
| <link rel=index | href=frontpage.html> |

| | |
|---|---|
| <link rel=up | href=europe-section.html> |

| | |
|---|---|
| <link rel=previous | href=somestory.html> |

| | |
|---|---|
| <link rel=next | href=someotherstory.html> |

Similar to the first example, the documents in the HTML metadata may be available for loading from the same directory of the web server as the current webpage. However, the HTML metadata may alternatively reference external documents available from another directory or server, or documents which are embedded in the current webpage.

Based on the link attributes in the example above, the browser may translate the logical metadata (e.g. “previous”) to a directional navigation command (e.g. “Left”). The following is an example of CSS code that defines such a translation:

```
@-o-navigation {
  nav-up: link-rel(index);
  nav-right: link-rel(next);
  nav-down: link-rel(up);
  nav-left: link-rel(previous);
}
```

Whether the CSS coding of the first example above, or the HTML metadata of the second example above, is used to define webpages auto-triggered by certain directional navigation commands can be left to the author of the webpage. Both alternatives will give the same result on the client side. However, webpage authors may use link attributes in web documents in order to create a logical relationship between documents without providing any translation to directional navigation commands that are implemented by gestures (or other inputs). Consequently, a client side “default” style sheet may be used in order to create default associations. For example, attributes like “next” and “forward” may by default be connected to a “Right” navigation command, while “previous” and “back” are connected to a “Left” navigation command. Similarly, attributes “index” and “home” may be connected to an “Up” navigation command, and “advertising” and “footnotes” may be connected to a “Down” navigation command.

It will be understood that this means several conflicting definitions can be declared for one webpage document. For example, a webpage document may include CSS that directly connects or associates a link with a directional navigation command. The same document may include link attributes that are associated with directional navigation commands according to definitions in an external CSS style sheet. And finally, there may be a third set of definitions in a client-side style sheet. These conflicts may be handled according to normal CSS priority, such that the last rule specified wins if the rules otherwise have the same weight, that author defined rules win over reader's rules (e.g. the client side definitions are only used if there are no conflicting author's rule), and that rules designated “!imprtant” win over rules not so designated.

However, the invention is not limited in this respect, and it is within the scope of the invention to assign priorities that are otherwise in conflict with standard CSS priorities.

Furthermore, according to another aspect of the invention, the lack of definitions in CSS and/or HTML metadata may initiate further analysis of the webpage document, including an analysis of link text or words in URLs and even a directory listing or an analysis of links in an index page. For example, if an index page is loaded first, a structure of pages can be assumed based on a sequence of links in the index page, and the browser can remember that when e.g. the third document in the index is loaded, the second document linked-to in the index should be loaded if a “Left” navigation command is performed, and the fourth document in the index should be loaded if a “Right” navigation command is performed.

Returning now to FIG. 4, after the analysis of operation S420 has been performed in accordance with any combination of the methods discussed above, the webpage can be rendered in accordance with operation S430. Thereafter, navigation may be performed based on any directional navigation commands as defined according to the analysis of S420. For instance, in S440, a determination can be made as to whether any gesture or input for performing a directional navigation command has been received while the current webpage is active. If so, a determination may then be made in S450 as to whether the corresponding directional navigation command is correlated to a URL or URI that points to an embedded document. If so (“Yes” in S450), the browser 200 may interpret the code of the embedded document to render it on the screen according to operation S460. However, if the directional navigation command is not correlated to an embedded document (“No” in S450), but to an external document instead, the browser 200 may be programmed to return to operation S410 to load the new webpage, either from the same server or a different one as the previously loaded page.

It should be noted that a web browser 200 could be programmed to implement both the first aspect (Screen Pages method) and the second aspect (Auto-Triggered Pages method) according to an exemplary embodiment. When implementing both methods together, the browser 200 may be configured to lay out the discrete screen pages of the loaded webpage either from top-to-bottom or left-to-right. Consider the example where the webpage is laid out into discrete screen pages from top-to-bottom. In this example, the Auto-Triggered Pages feature may be implemented such that, when the last or “bottommost” discrete screen page is displayed, the browser 200 would load a “Down”-related document (i.e., the document associated with the ‘nav-down’ property) in response to a “Down” navigation command by the user, and display the previous discrete screen page in response to an “Up” navigation command. In the same example, if the first or “uppermost” discrete screen page is displayed, the document associated with the ‘nav-up’ property would be loaded in response to an “Up” navigation command, while the next discrete screen page would be displayed by a “Down” navigation command. In this same example, each of the discrete screen pages would be considered the “leftmost” and “rightmost” screen pages (i.e., the left and right edges of the overall webpage) such that “Left” and “Right” navigation commands causes the browser 200 to load documents associated with the ‘nav-left’ and ‘nav-right’ properties, respectively.

Furthermore, if both Screen Pages and Auto-Triggered Pages are implemented together in a browser 200, it is contemplated that the current webpage could be laid out into discrete screen pages according to a grid/matrix (e.g., like displaying a map). In this case, several pages may be placed along each of the edges.

However, it would also be possible to configure a browser 200 to implement only one or the other of the above-described Screen Pages and Auto-Triggered Pages methods according to an alternative embodiment.

The exemplary embodiments presented herein are described in terms of current web technologies including standards such as HTML, CSS and HTTP. However, the invention is not limited to these examples, and may also be implemented using other standards, protocols and data formats for storing, transmitting and presenting content.

Furthermore, while the examples are contemplated as being implemented on computing devices 100 which operate as client devices running a web browser 200 or some other user agent software locally, the functionality provided by the invention may alternatively be located, in part or in whole, in the network, for example, on a proxy server or transcoding server.

It should also be understood that while the exemplary embodiments include certain combinations of features, some of which are not present in all embodiments, the invention is not limited to the combinations explicitly discussed in the foregoing. Consequently, features that are not explicitly described as depending on each other in order to operate, may or may not be present in a particular embodiment of the invention whether or not they have been described as such above. For the sake of brevity and clarity, all possible permutations of disclosed features have not been explicitly listed, but persons with skill in the art will understand that the omission of certain such combinations does not mean that they are not part of the invention as disclosed through the examples presented herein.

What is claimed is:

1. A method implemented by a web browser for displaying a markup language document comprising:
retrieving the document via a network;
rearranging the document's content into discrete screen pages; and
individually displaying one or more of the discrete screen pages.

2. The method of claim 1, wherein the rearranging step includes:
categorizing at least one element of content in the document, and
applying a rule to modify the at least one element, or modify a relationship between the at least one element and another element of content, based on its categorization.

3. The method of claim 2, wherein the applied rule is one of a plurality of rules chosen based on dimensions of a display viewport or browser window.

4. The method of claim 2, wherein the applied rule is one of a plurality of rules which include at least one of:
a rule specifying in which of the discrete screen pages an image element of the document is to be displayed,
a rule specifying in which of the discrete screen pages an advertisement element of the document is to be displayed, and
a rule specifying that a disclaimer element of the document is to be displayed in the last of a defined sequence of the discrete screen pages, or in a particular location of each of the discrete screen pages.

5. The method of claim 1, further comprising:
analyzing a modified layout of the document, resulting from the rearrangement of the document's content into the discrete screen pages, to determine whether a blank area is available in at least one of the discrete screen pages, and
if the blank area is available, selecting an advertisement to be inserted within the blank area when the corresponding discrete screen page is displayed.

6. The method of claim 1, further comprising:
defining one or more directional navigation commands,
wherein each of the one or more directional navigation commands causes the web browser to perform one of the following:
switch to displaying a different discrete screen page than the one currently displayed,
switch to displaying a document embedded within the retrieved document, and
retrieve via the network another markup language document to be displayed.

7. The method of claim 6, wherein a sequence is defined for the discrete screen pages into which the document's content is rearranged, and the defining step includes:
defining a “Next” command for displaying the next discrete screen page in relation to a currently displayed discrete screen page according to the defined sequence, and
defining a “Previous” command for displaying the previous discrete screen page in relation to the currently displayed discrete screen page, according to the defined sequence.

8. The method of claim 6, wherein the defining step includes:
processing cascading style sheet (CSS) code in the retrieved document that correlates the uniform resource identifier (URI) of a particular embedded or external document to a particular directional navigation command implemented by a user gesture or input.

9. The method of claim 6, wherein the defining step includes:
processing metadata that defines a logical relationship between the retrieved document and a particular embedded or external document, and
processing cascading style sheet CSS code in the retrieved document to translate the logical relationship to a particular directional navigation command which causes the web browser to display the particular embedded or external document.

10. The method of claim 9, wherein the directional navigation command corresponds to a touchscreen gesture by the user to navigate beyond the edge of the webpage in a particular physical direction.

11. A non-transitory computer-readable medium on which is stored code for a web browser which, when executed by a computer processor, performs a process comprising:
retrieving a markup language document via a network;
rearranging the document's content into discrete screen pages; and
individually displaying one or more of the discrete screen pages.

12. The computer-readable medium of claim 11, wherein the rearranging step includes:
categorizing at least one element of content in the document, and
applying a rule to modify the at least one element, or modify a relationship between the at least one element and another element of content, based on its categorization.

13. The computer-readable medium of claim 12, wherein the applied rule is one of a plurality of rules chosen based on dimensions of a display viewport or browser window.

14. The computer-readable medium of claim 12, wherein the applied rule is one of a plurality of rules which include at least one of:
a rule specifying in which of the discrete screen pages an image element of the document is to be displayed,
a rule specifying in which of the discrete screen pages an advertisement element of the document is to be displayed, and
a rule specifying that a disclaimer element of the document is to be displayed in the last of a defined sequence of the discrete screen pages, or in a particular location of each of the discrete screen pages.

15. The computer-readable medium of claim 11, wherein the process further comprises:
analyzing a modified layout of the document, resulting from the rearrangement of the document's content into the discrete screen pages, to determine whether a blank area is available in at least one of the discrete screen pages, and
if the blank area is available, selecting an advertisement to be inserted within the blank area when the corresponding discrete screen page is displayed.

16. The computer-readable medium of claim 11, wherein the process further comprises:
defining one or more directional navigation commands,
wherein each of the one or more directional navigation commands causes the web browser to perform one of the following:
switch to displaying a different discrete screen page than the one currently displayed;
switch to displaying a document embedded within the retrieved document; and
retrieve via the network another markup language document to be displayed.

17. The computer-readable medium of claim 16, wherein a sequence is defined for the discrete screen pages into which the document's content is rearranged, and the defining step includes:
defining a “Next” command for displaying the next discrete screen page in relation to a currently displayed discrete screen page according to the defined sequence, and
defining a “Previous” command for displaying the previous discrete screen page in relation to the currently displayed discrete screen page, according to the defined sequence.

18. The computer-readable medium of claim 16, wherein the defining step includes:
processing cascading style sheet (CSS) code in the retrieved document that correlates the uniform resource identifier (URI) of a particular embedded or external document to a particular directional navigation command implemented by a user gesture or input.

19. The computer-readable medium of claim 16, wherein the defining step includes:
processing metadata that defines a logical relationship between the retrieved document and a particular embedded or external document, and
processing cascading style sheet CSS code in the retrieved document to translate the logical relationship to a particular directional navigation command which causes the web browser to display the particular embedded or external document.

20. The computer-readable medium of claim 19, wherein the directional navigation command corresponds to a touchscreen gesture by the user to navigate beyond the edge of the webpage in a particular physical direction.

21. An electronic device including a processor on which is executed the web browser for performing the method of claim 1.
